(19) United States
(12) Patent Application Publication
(10) Pub. No.: US 2004/0123808 A1
(43) Pub. Date: Jul. 1, 2004

(54) Animal proof bird feeder

(76) Inventor: Michael Martin Dunn, Concord, NH (US)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/334,429

(22) Filed: Dec. 30, 2002

(51) Int. Cl. A01K 61/02

(52) U.S. Cl. 119/57.9

(57) ABSTRACT

A bird feeder comprising an elongate bird feed container open a top end and having a base closing a bottom end thereof. A hanging member for hanging the bird feeder and a removable cover with both an open position, in which the cover is spaced from the top end to facilitate supplying bird feed, and a closed position in which the cover covers the top end. A cage structure for encasing the bird feed container. The bird feed container is a material with a plurality of access openings formed therein which are sized to retain bird feed but also facilitate dispensing and feeding of the bird feed therethrough when accessed by a desired bird. An outer surface of the material of the bird feed container is spaced sufficiently away from an inwardly facing surface of a sidewall of the cage structure to allow only selected or small birds to access and retrieve bird feed while preventing undesired larger non-clingy birds and animals from accessing bird feed contained within the bird feed container.

### FIELD OF THE INVENTION

The present invention relates to a bird feeder within an open framework or cage which facilitates feeding of bird feed to smaller desired birds but prevents other non-clinging birds or animals from feeding from the bird feeder.

### BACKGROUND OF THE INVENTION

Numerous bird feeders are currently available in the marketplace. These currently available bird feeders have many different shapes, configurations and designs for ensuring bird feed is readily available at specific feeding or access ports for the birds and a variety of these bird feeders are specifically directed at preventing animals other than birds, e.g., squirrel, raccoons, etc., from feeding from the bird feeders. Regardless of the design of the bird feeder that is utilized, all bird feeders generally have a single feed supply opening provided at the top of the feeder for introducing bird feed into the bird feeder, as well as to facilitate cleaning of the bird feeder.

A well known problem with bird feeders is that unwanted animals, such as squirrels, racoons or any of the numerous menagerie of woodland mammals, and even certain unwanted birds, e.g., crows, pigeons, and other non-clinging birds, are attracted to the bird feeder. Numerous devices for preventing these undesirable animals from feeding at bird feeders are known in the art. For example, an inverted cone, commonly known as a squirrel baffle, is often installed below a bird feeder mounted on a pole to provide a physical barrier and prevent squirrels from climbing the pole and accessing the feeder. Many hanging feeders have domes mounted over the feed container which provides limited traction for squirrels or other animal attempting to access the bird feeder. Often, the edge of the dome partially defines a gap of limited size through which access to the bird feeder is restricted.

Additionally, cages or open works with sized openings that allow certain size birds complete access to the feed container inside the cage, while keeping unwanted birds and/or pests out, are known. These cages are usually cylindrical in shape and serve a utilitarian purpose.

### SUMMARY OF THE INVENTION

Wherefore, it is an object of the present invention to overcome the above mentioned shortcomings and drawbacks associated with the prior art.

Another object of the present invention is to provide a bird feeder incorporating a open framework or cage that completely encases the bird feed container to prevent unwanted birds and other animals, e.g., squirrel, raccoons, etc., from feeding from the bird feed container.

A further object of the present invention is to provide a mesh bird feed container which facilitates feeding a bird from virtually anywhere along a longitudinal length as well as generally the entire circumference of the bird feed container.

Still another object of the present invention is to provide a bird feed container which is sufficiently permeable so as to retain bird feed therein, but also readily dispenses the bird feed through virtually any access opening formed within the sidewall of the bird feed container.

A further object of the present invention is to provide a bird feeder which is resistant to rust and corrosion so that the bird feeder retains its aesthetic appeal for many years of use.

Yet another object of the present invention is to provide a bird feeder which is relatively simple and inexpensive to manufacture, but is durable and able to withstand the elements of the environment.

Another object of the present invention is to encase a mesh material by an outer cage whereby the outer surface of the mesh material is sufficiently space from the inner surface of the outer cage to allow only the heads and/or shoulders of selected birds to be able to pass through the passage openings in the outer cage and access the bird feed housed through the access opening in the mesh material and prevent other non-clinging birds and animals from accessing the bird feed.

The present invention also relates to a bird feeder, for holding a quantity of bird feed, comprising: an elongate bird feed container being open at a top end thereof and having a base closing a bottom end thereof, and the bird feed container defining a longitudinal axis; a hanging member connected to the bird feeder for hanging the bird feeder; a removable cover for covering the open top end of the bird feed container, the cover having both an open position, in which the cover is spaced from the top end to facilitate supplying bird feed into the bird feed container through the open top end, and a closed position, in which the cover engages with and covers the top end of the bird feed container; and a cage structure for encasing the bird feed container; wherein the bird feed container is manufactured from a mesh material, or some other conventional feeder such as a tube feeder or a hopper feeder, which has one or more access openings formed therein and the access openings are sized to retain bird feed, once the bird feed is poured therein, but also facilitate dispensing and feeding of the bird feed therethrough when accessed by a desired bird.

The present invention also relates to a method of providing a bird feeder for holding a quantity of bird feed, comprising: forming an elongate bird feed container with an open top end and with a base closing a bottom end of the elongate bird feed, and defining a longitudinal axis by the bird feed container; connecting a hanging member to the bird feeder to facilitate hanging the bird feeder; covering the open top end of the bird feed container with a removable cover, the cover having both an open position, in which the cover is spaced from the top end to facilitate supplying bird feed into the bird feed container through the open top end, and a closed position, in which the cover engages with and covers the top end of the bird feed container; encasing the bird feed container with a cage structure; and manufacturing the bird feed container from a mesh material, or some other conventional feeder such as a tube feeder or a hopper feeder, which has one or more access openings formed therein and sizing the access openings to retain bird feed, once the bird feed is poured therein, but also facilitate dispensing and feeding of the bird feed therethrough when accessed by a desired bird.

### BRIEF DESCRIPTION OF THE DRAWINGS

The above and other objects of the invention will now be described, by way of example, with reference to the accompanying drawings in which:

FIG. 1 is a diagrammatic front perspective view of the bird feeder of the present invention;

FIG. 2 is a diagrammatic cross sectional view of the bird feeder of FIG. 1 with the cover shown in a raised position;

FIG. 3 is a diagrammatic front elevational view of the bird feeder of FIG. 1;

FIG. 4 is a diagrammatic top plan view of FIG. 1 with the cover shown in a raised and tilted position;

FIG. 5 is a diagrammatic top plan view of FIG. 1 with the cover shown in a raised and tilted position and bird feed loaded within the bird feed container;

FIG. 6 is a diagrammatic cross section view along section line 6-6 of FIG. 3;

FIG. 7 is a diagrammatic bottom plan view of the bird feeder of FIG. 1;

FIG. 8 is a diagrammatic perspective view showing use of the bird feeder of the present invention;

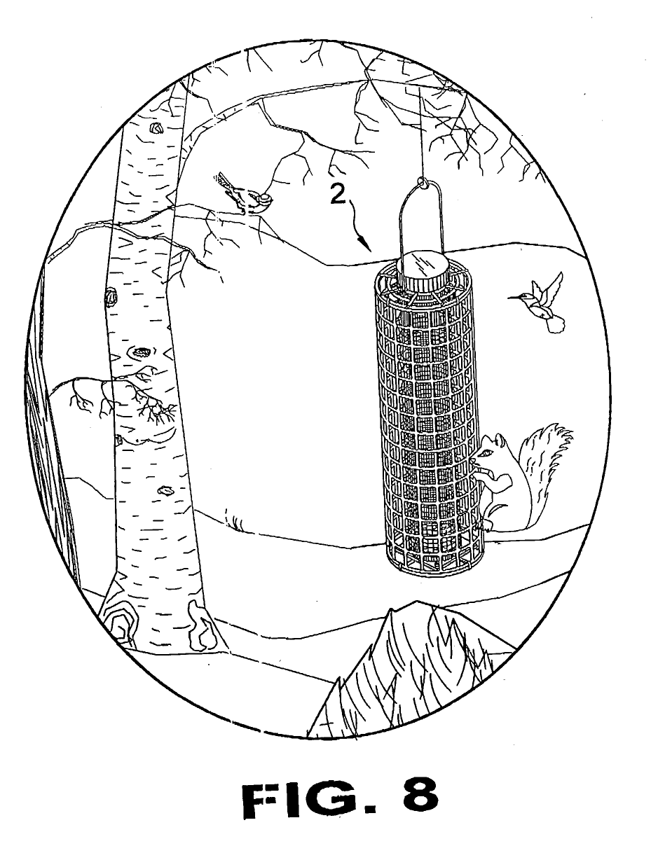

FIG. 9 is a diagrammatic partial cross section front elevational view showing a second embodiment of the bird feeder of FIG. 1;

FIG. 10 is a diagrammatic partial cross section front elevational view showing a third embodiment of the bird feeder of FIG. 1; and

FIG. 11 is a diagrammatic partial cross section front elevational view showing a fourth embodiment of the bird feeder of FIG. 1.

### DETAILED DESCRIPTION OF THE INVENTION

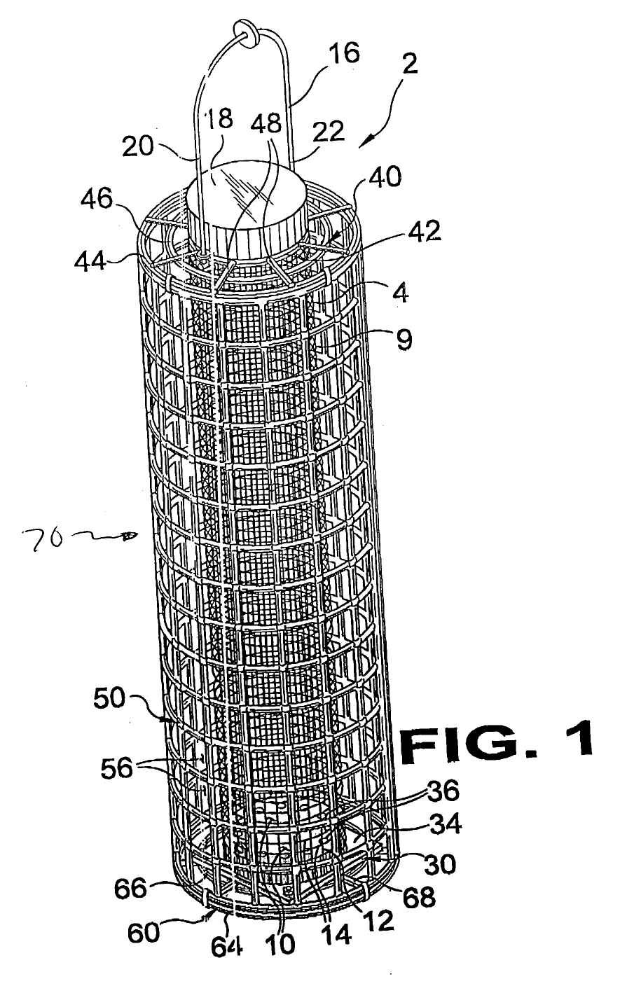

Turning now to FIGS. 1-7, a detailed description of the various components of the bird feeder of the present invention will now be discussed. As can be seen in those Figures, the bird feeder 2 generally comprises a cylindrical elongate bird feeder tube or container 4 which is open at both opposed ends thereof, i.e. the top end 6 and the bottom end 8. The cylindrical elongate bird feed container 4 defines a longitudinal axis A of the bird feeder 2 and is typically manufactured from a fine mesh material 9. The mesh material 9 has a plurality of access openings 10 formed therein which each have a cross section open area of between about 0.0225 and about 0.1225 square inches, more preferably each has a cross section open area of between about 0.04 and about 0.09 square inches and most preferably each has a cross section open area of about 0.0625 square inches. It is to be appreciated that the size of mesh material can vary depending upon the size of the particular seed to be retained therein. The mesh material 9 is typically manufactured from a tough durable material such as steel, zinc, cast zinc, stainless steel, aluminum, durable plastic, or other conventional but well known materials. The mesh material 9 is sized to retain bird feed within the bird feed container 4, once the bird feed is poured therein, but also allow desired birds to feed and removed retained bird feed through the access opening 10 in the mesh material 9 defining the bird feed container 4. Each one of these access openings 10 forms a feeding port for supplying bird feed to a desired bird. The bird feed container 4 may be cylindrical in shape but other shapes such as, for example, a container having a square transverse cross section, a rectangular transverse cross section, an octagonal transverse cross section, etc., may be utilized as well.

The mesh material 9 of the bird feed container 4 is defined by a plurality of longitudinal elements 12 and a plurality of spaced apart horizontal elements 14. The plurality of horizontal elements 14 are attached to the plurality of longitudinal elements 12 by welding, soldering or some other conventional or well known fastening technique. The preferred spacing of the adjacent longitudinal elements 12 from one another is from about 1/16 to about ⅓ of an inch, and most preferably the spacing of the adjacent longitudinal elements 12 from one another is about ¼ of an inch or so. A preferred spacing of the adjacent horizontal elements 14 from one another is from about 1/16 to about ⅓ of an inch, and most preferably the spacing of the adjacent longitudinal elements 12 from one another is about ¼ of an inch or so.

An inverted U-shaped hanger member 16 is attached to a top portion of the bird feeder 2 to suspend or hang the bird feeder 2 from a desired a hook, a tree limb, a rope, or some other member, as is conventional and well known in the art. The hanger member 16 has a pair of legs 20, 22 and is preferably manufactured from a suitable thicker gauged wire that is pivotably secured to cylindrical rod 26 which extends through a top portion of the mesh material 9 and projects radially outward on opposed sides of the mesh material 9 adjacent the top portion of the bird feed container 4. A free end of each leg of the hanger member 16 is received by and extends through a hanging hole 24 in the cylindrical rod 26. A releasable cover 18 is sized to enclose and snugly receive the outer surface of the top end 6 of the bird feeder 2. The cover 18 has a pair of opposed ears 28 and an aperture is formed in each ear. The apertures each receive a respective leg 20 or 22 of the hanger member 16 to allow sliding motion of the cover 18 along the hanger member 16. The hanging holes 24 in the cylindrical rod 26 also allow sliding motion of the hanger member 16 relative to the cylindrical rod 26. Preferably a substantial length of each leg 20, 22 of the hanger member 16 extends parallel to one another as well as to the longitudinal axis A of the bird feeder 2, when the hanger member 16 is in a vertical orientation hanging the bird feeder 2 from a suitable member, and such arrangement facilitates sliding motion of the cover 18 therealong.

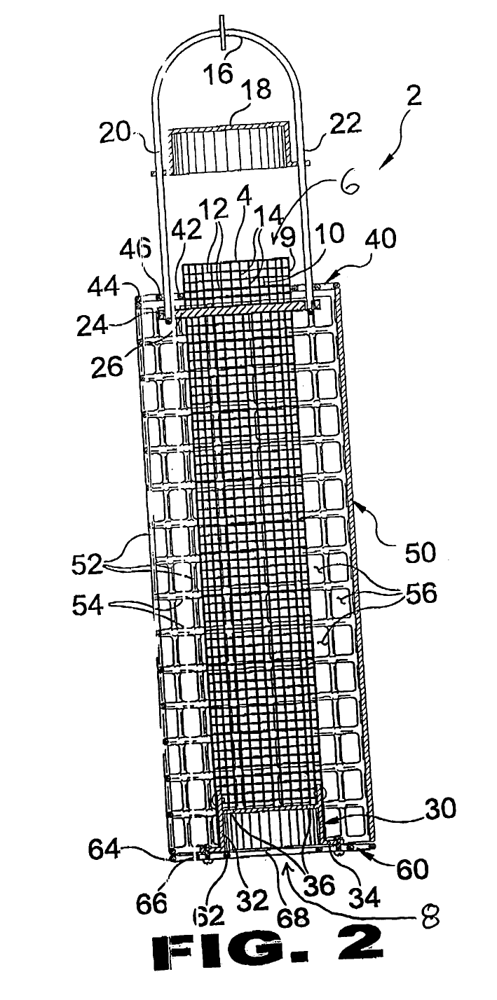

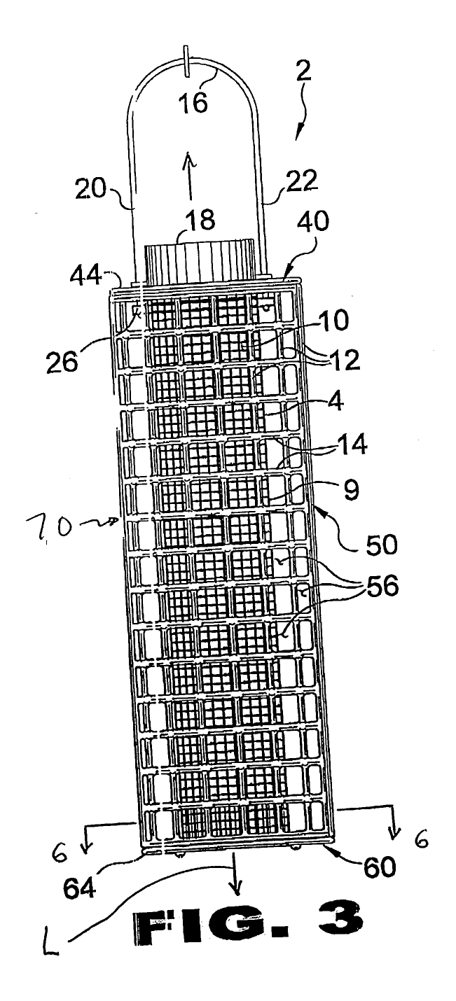

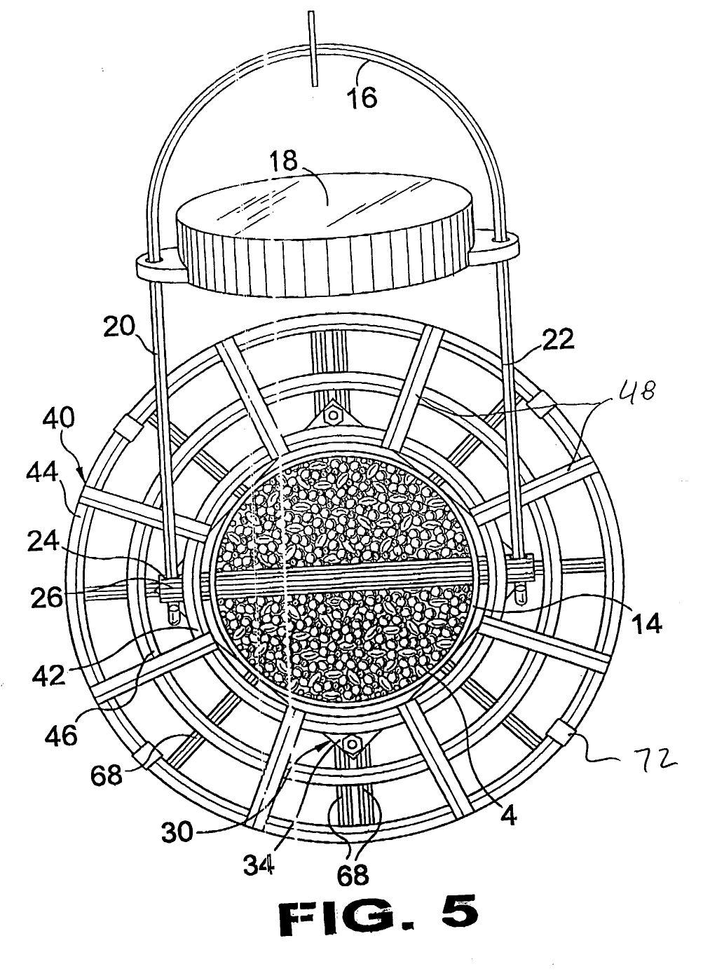

The removable cover 18 has both a raised or open position, in which the cover 18 is spaced from the top end 6 of the bird feed container 4, and a closed position, in which the cover 18 snugly receives or engages with the top end of the bird feed container 4. When the cover 18 slides along the legs 20, 22 of the hanger member 16 to its open position, spaced from the top end of the bird feed container 4 (FIGS. 2, 4 and 5), this provides access to the feed supply access opening 10 for supplying, pouring or loading bird feed into the bird feed container 4. Once a sufficient amount of bird feed has been poured into or supplied to the top open end of the bird feed container 4 (FIG. 5), the cover 18 is then slid along the legs 20, 22 of the hanger member 16 to its closed position where the cover 18 snugly receives and encases the top end of the bird feed container 4 (FIGS. 1 and 3). Such engagement between the cover 18 and the top end of the bird feed container 4 generally provides a sufficient watertight cover or closure for the bird feed container 4 to minimize the amount of moisture which may contact the bird feed, contained within the bird feed container 4, during use.

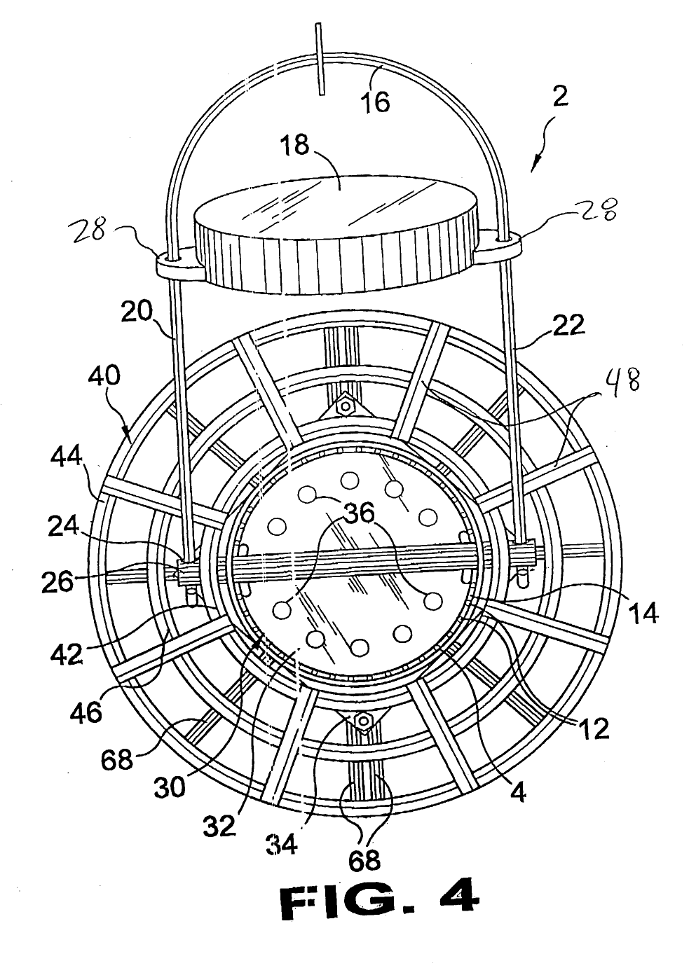

A base 30 is generally fixedly or permanently attached to a sidewall of the mesh material 9 of the bird feed container 4, adjacent a bottom end 8 thereof (FIGS. 2 and 4). Such fixed or permanent attachment of the base 30 to the mesh material 9 can be, for example, by an adhesive, a plurality of mating threaded fasteners such a nut and bolt combination, an interference fit between those two components, etc. The fastening mechanism fastens the base 30 to the bottom end of the bird feed container 4 and the base 30 forms a stop to prevent bird feed from falling out though the bottom of the mesh material 9 of the bird feed container 4. The base 30 may be a member which has a raised cylindrical portion 32, which is received by the bottom end of the bird feed container 4, and a wider head portion 34 which is larger than the bottom end of the bird feed container 4 to function as a stop. The base 30 preferably is provided with one or more drainage holes 36, e.g. between one and twelve perimeter drainage holes (FIG. 4), which extend through the bottom surface of the base 30 to facilitate drainage of any moisture which is contained within the bird feeder container 4.

The bird feeder 2, according to the present invention, is encased or surrounded by a top planar open framework or cage 40, a bottom planar open framework or cage 60 and a sidewall open framework or cage 50. The top planar open framework or cage 40, the bottom planar open framework or cage 60 and the sidewall open framework or cage 50 are all connected with one another to from an integral unitary cage structure 70.

The sidewall cage 50 is defined by a plurality of longitudinal members 52 and a plurality of spaced apart horizontal members 54. The plurality of horizontal members 54 are attached to the plurality of longitudinal members 52 by welding or some other conventional or well known fastening technique. Each one of the horizontal members 54 and the longitudinal members 52 is preferably covered or sealed by a durable coating or casing, e.g., covered by a plastic layer of material or laminate such as PVC or possibly a powder coat finish for example, to minimize the possibility of the sidewall cage 50 rusting and also provide a decorative finish to the sidewall cage 50. The preferred center to center spacing of the adjacent longitudinal members 52 from one another is from about ¾ to about inches 1½, more preferably the spacing of the adjacent longitudinal members 52 from one another is from about ⅞ to about inches 1¼, and most preferably the spacing of the adjacent longitudinal members 52 from one another is about 1 inch. A preferred center to center spacing of the adjacent horizontal members 54 from one another is from about¾ to about inches 1½, more preferably the spacing of the adjacent longitudinal members 52 from one another is from about ⅞ to about inches 1¼, and most preferably the spacing of the adjacent longitudinal members 52 from one another is about 1 inch.

The plurality of longitudinal members 52 and the plurality of spaced apart horizontal members 54 define a plurality of feeding passages 56 in the sidewall cage 50. Each feeding passage 56 has a cross section open area of between about 0.56 and about 2.25 square inches, more preferably has a cross section open area of between about 0.77 and about 1.56 square inches and most preferably has a cross section open area of about 1 square inch. The feeding passages 56, formed by the longitudinal members 52 and the horizontal members 54, are sized such that only the heads and/or the shoulders of smaller birds can pass readily therethrough and partially enter the cage structure 70 so that the beak of the bird may access and retrieve bird feed, via one of the access openings 10, contained within the bird feed container 4 while larger non-clingy birds or animals are unable to sufficiently stick or pass their heads, arms, legs and/or the shoulders through the cage structure 70 and thus can not access any of the bird feed, or only access an insubstantial amount of bird feed.

The top planar open framework or cage 40 is circular in shape and comprises a top inner circular collar 42 and a top outer circular collar 44 and at least one, possibly two or more, circular frame members 46 located therebetween (FIGS. 4 and 5). The top inner circular collar 42, the top outer circular collar 44 and at least one circular frame member 46 are all interconnected with one another by a plurality of top radially extending frame members 48. Each one of the top inner circular collar 42, the top outer circular collar 44 and at least one circular frame member 46 is preferably covered or sealed by a plastic layer of material or laminate such as PVC or possibly a powder coat finish to minimize the possibility of the top planar open framework or cage 40 rusting and also to provide decorative finish thereto. A preferred center to center spacing of the top inner circular collar 42, the top outer circular collar 44 and the at least one circular frame member 46 from one another is from about ¼ to about 1inch, more preferably the spacing is from one another is from about ⅜ to about ⅞ of an inch, and most preferably the spacing is about ⅝ of an inch. Preferably there are about eight radially extending frame members 48 although the number, location and spacing of the top radially extending frame members 48 from one another can vary depending upon the application and/or the particular design. The top inner circular collar 42, the top outer circular collar 44, the at least one circular frame member 46 and the top radially extending frame members 48 are spaced from one another to prevent any bird or animal from accessing the bird feed contained within the bird feed container 4 through the top planar open framework or cage 40.

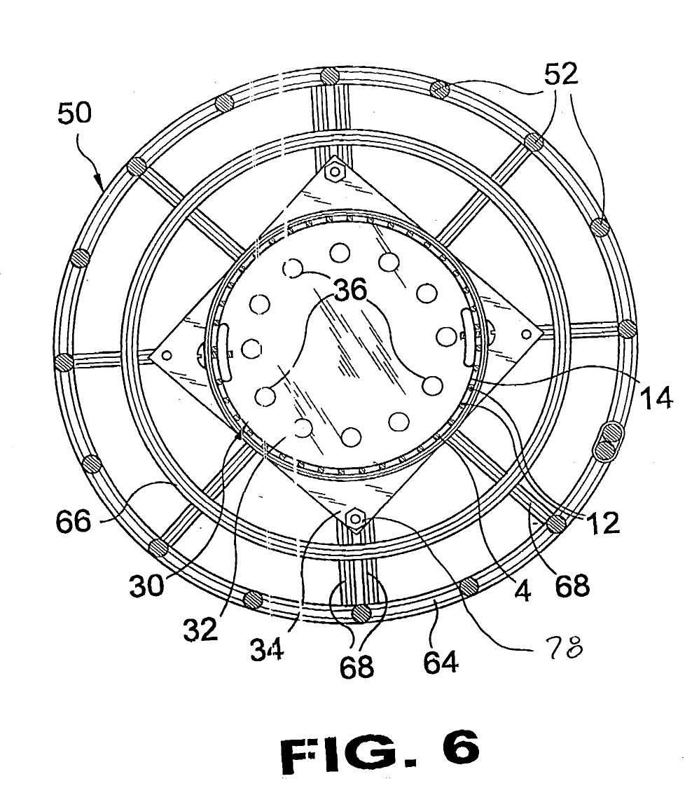

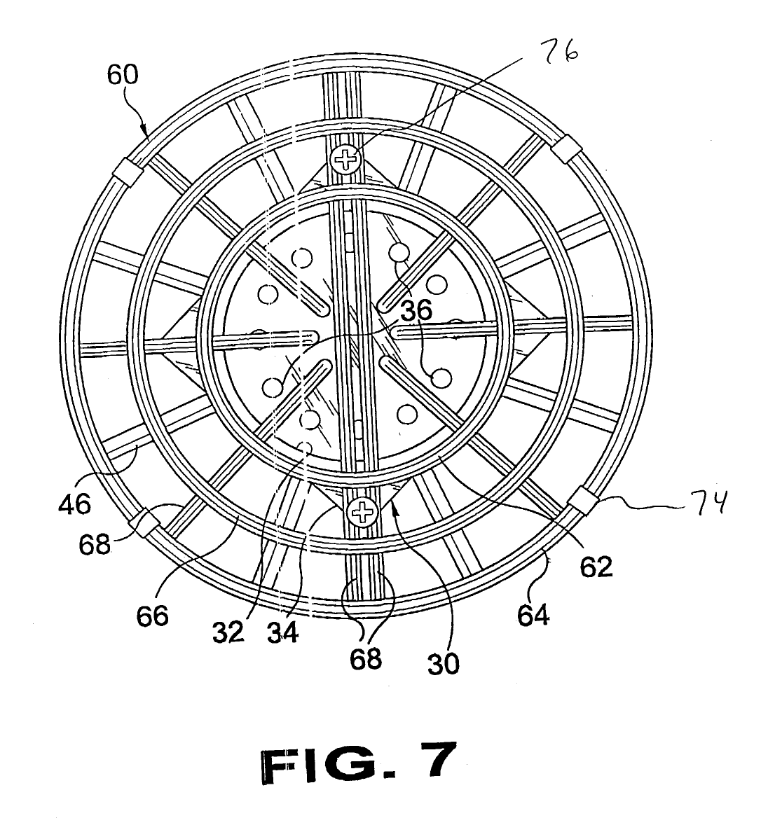

The bottom planar open framework or cage 60 comprises a bottom inner circular collar 62 and a bottom outer circular collar 64 and at least one, possibly two or more, circular frame member 66 located therebetween (FIGS. 6 and 7). The bottom inner circular collar 62, the bottom outer circular collar 64 and at least one circular frame member 66 are all interconnected with one another by a plurality of bottom radially extending frame members 68. Each one of the bottom inner circular collar 62, the bottom outer circular collar 64 and at least one bottom circular frame member 66 is preferably covered or sealed by a plastic coating or layer, for example, to minimize the possibility of the bottom planar open framework or cage 60 rusting and also provide a decorative finish thereto. A preferred center to center spacing of the bottom inner circular collar 62, the bottom outer circular collar 64 and the at least one bottom circular frame member 66 from one another is from about ¼ to about 1 inch, more preferably the spacing is from one another is from about ⅜ to about ⅞ of an inch, and most preferably the spacing is about ⅝ of an inch. Preferably there are about eight to ten radially extending frame members 68 although the number, location and spacing of the bottom radially extending frame members 68 can vary depending upon the application and/or the design. The bottom inner circular collar 62, the bottom outer circular collar 64, the at least one circular frame member 66 and the bottom radially extending frame members 68 are spaced from one another to prevent any bird or animal from accessing the bird feed contained within the bird feed container 4 through the bottom planar open framework or cage.

The top outer circular collar 42 of the top planar open framework or cage 40 is connected to a top portion of the sidewall cage 50 by a conventional top fastening member 72, e.g., two to four equally spaced apart metal clamps, two to four equally spaced apart strapping members, welding, glueing, or any other conventional fastening technique well known in this art. The bottom outer circular collar 62 of the bottom planar open framework or cage 60 is connected to a bottom portion of the sidewall cage 50 by a conventional bottom fastening member 74, e.g., two to four equally spaced apart metal clamps, two to four equally spaced apart strapping members, welding, glueing, or any other conventional fastening technique well known in this art.

The base 30 is also connected to the bottom planar open framework or cage 60 by a conventional fastening technique, e.g., a pair of opposed mating nut and bolt assemblies 76 and 78 interconnecting the base with the bottom planar open framework or cage. Other fastening techniques, such as, metal clamps, a strapping members, welding, glueing, or any other conventional fastens well known in this art may also be utilized.

An outer surface of the bird feed container 4 is spaced sufficiently from an inwardly facing surface of the sidewall cage 50 to further assist with only allowing the beaks of the smaller birds to access and retrieve bird feed contained within the bird feed container 4 while preventing larger non-clingy birds or animals from reaching or accessing any, or only an insubstantial amount, of the bird feed contained within the bird feed container 4. A preferred center to center spacing of the outer surface of the bird feed container 4 from the inwardly facing surface of the sidewall cage 50 is from about ¾ to about 1¾ inches, more preferably the spacing is from about 1 to about 1½ inches, and most preferably the spacing is about 1¼ of an inch. Such spacing of the outer surface of the bird feed container 4 from the inwardly facing surface of the sidewall cage functions as a “squirrel block” to minimize the possibility of an arm or a hand of an animal, such as a squirrel, from passing through one of the feeding passages 56 and reaching or accessing the bird feed contained within the bird feed container 4. That is, the size of the feeding passages 56 formed in the sidewall cage 50 in combination with the spacing of the outer surface of the bird feed container 4 from the inwardly facing surface of the sidewall cage 50 essential prevent a squirrel being able to reach or grasp the feed contained within the bird feed container 4 by its hands.

It is to be appreciated that if the size of the feeding passages 56 is increase for a particular application, than the spacing of the outer surface of the bird feed container 4 from the inwardly facing surface of the sidewall cage should generally also be increased. Conversely, if the size of the feeding passages 56 is decrease, than the spacing of the outer surface of the bird feed container 4 from the inwardly facing surface of the sidewall cage generally may also be decreased. A typically ratio of the size of the feeding passage to the spacing of the outer surface of the bird feed container 4 from the inwardly facing surface of the sidewall cage is 4:5.

In a preferred form of the invention, both the mesh material 9 and the side wall 50 of the cage structure 70 are cylindrical and arranged substantially concentrically with respect to one another.

In a preferred form of the invention, a top portion of the mesh material 9 projects up through the cage structure 70, by about ¼ to ½ inch or so to facilitate engagement between the removable cover 18 and the bird feed container.

Typically the longitudinal elements 12 and the horizontal elements 14, forming the mesh material 9, are manufactured from a 12-18 gauge wire while the horizontal members and the longitudinal members, forming the cage structure 70, are manufactured from a 12-18 gauge wire. The inverted U-shaped hanger member 16 is typically manufactured from a 6-18 gauge wire, for example.

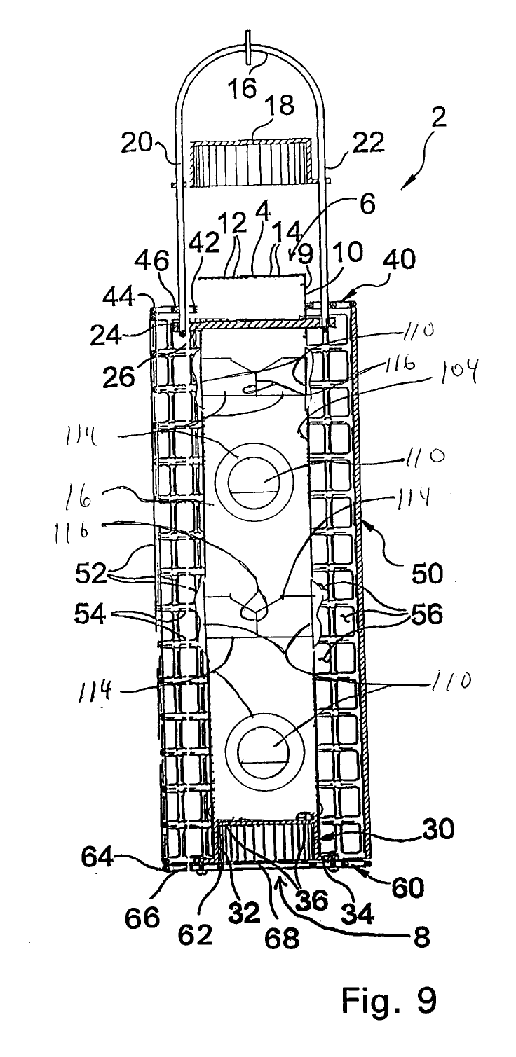

Turning now to FIG. 9, a variation of the bird feeder of FIG. 1 is shown. As this second embodiment is very similar to the first embodiment, only the differences between this second embodiment and the first embodiment are discussed in detail below.

The major difference between this embodiment and the first embodiment is the replacement of the mesh material with a conventional plastic tube bird feed container 104. The plastic tube bird feed container 104 is generally cylindrical in shape and is open at both opposed ends thereof, i.e. the top end 6 and the bottom end 8, and the cover 18 and the base 30 are respectively engageable with the top and bottom open ends 6, 8, as with the previous embodiment. The conventional plastic tube bird feed container 104 is typically manufactured from a tough durable transparent plastic material such as cellulose acetate or polycarbonate, for example, and has a plurality of apertures 110 formed in a sidewall thereof. The apertures 110 are generally circular or oval in shape.

Each pair of apertures 110 is generally located diametrically opposed to one another and each one of the plurality of pairs of spaced apart apertures 110 is sufficiently sized to receive a corresponding feeding port 114 therein. The feeding ports 114 have a conventional construction and are each received by one of the apertures 110 formed in the sidewalls 16 of the bird feeder container 10. The feeding ports 114 are of arcuate construction with an inlet opening substantially concentric with the apertures 110 and a downwardly facing opening to permit a bird to retrieve bird feed from the bird feeder when feeding.

Each feeding port 114 has an end surface 116 extending into the container 10 and the end surfaces 116 of the two adjacent feeding ports 114 abut against one another and are fastened to one another by a screw and nut assembly (not shown), or some other conventional but releasable fastening mechanism, extending though the end surfaces to securely attach the pair of adjacent feeding ports with one another and within the pair of diametrically opposed apertures 110 of the bird feeder container 10. The feeding ports 114 are typically manufactured from a tough material such as stainless steel, aluminum, durable plastic, or other conventional but well known materials. It is to be appreciated that generally two, three or four pairs of adjacent feeding ports 114 are supported by the bird feeder, as these types of feeding ports are conventional and well known in the art no further discussion is provided.

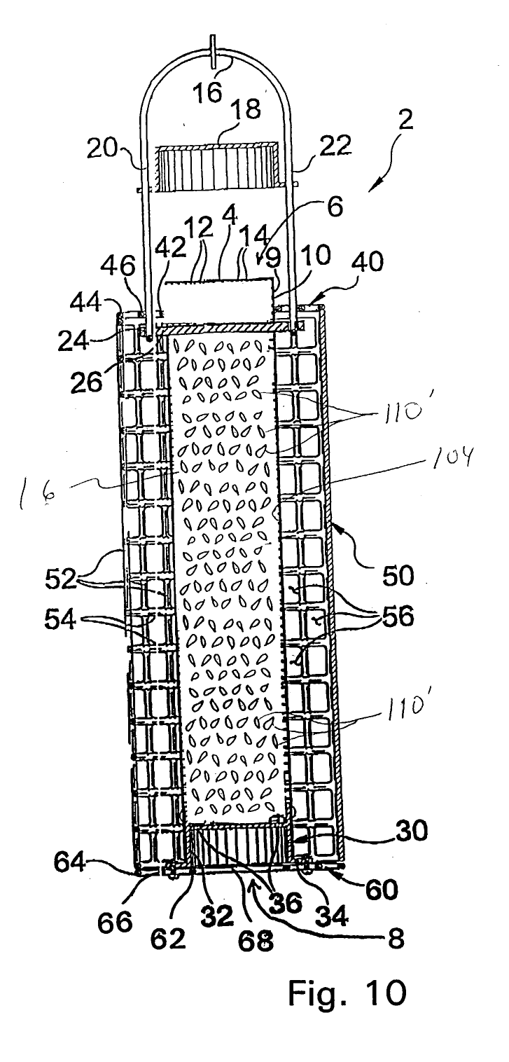

With reference now to FIG. 10, a further variation of the bird feeder of FIG. 1 is shown. As this third embodiment is very similar to the second embodiment, only the differences between the third and the second embodiments are discussed in detail below.

The only difference between the third embodiment and the second embodiment is the size and shape of the apertures 110′ and the elimination of the structural feeding ports. As with the second embodiment, the apertures 110′ are formed directly in the sidewall 16 of the plastic tube bird feed container 104 but are much smaller in size and are teardrop shaped. In addition, many more apertures 110′ are formed at a plurality of spaced apart locations in the sidewall of the plastic tube bird feed container 104. The plurality of apertures 110′ may be randomly formed in the sidewall 16 or may be formed in the sidewall 16 in a uniform pattern. Each of the plurality of apertures 110′ is sufficiently small in size to retain bird seed within the bird feed container 104 while also being sufficiently large enough in size to facilitate dispensing for bird seed through the aperture 110′ to a feeding bird. Due to the tear drop shape of the apertures 110′, the desired bird seed, such as thistle seed for example, is less prone to fall out through the open of the apertures 110′ and be retained by the bird feed container 104. Nevertheless, desired birds are still able to retrieve seed through the apertures 110′ formed in the sidewall of the plastic tube bird feed container 104 and feed therefrom.

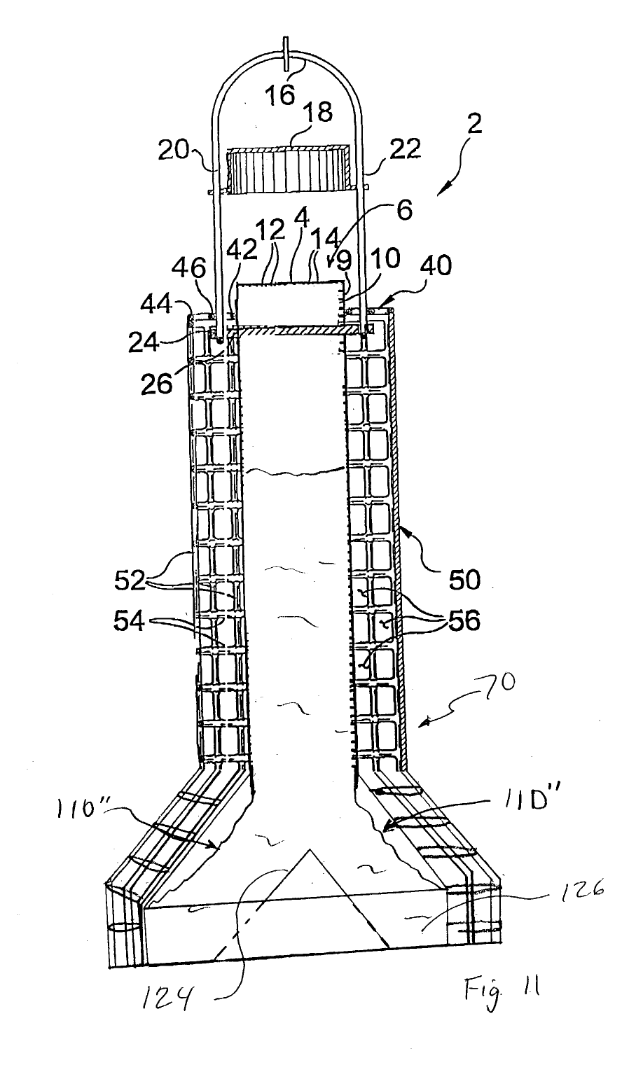

Turning now to FIG. 11, a variation of the bird feeder of FIG. 1 is shown. As this fourth embodiment is very similar to the first embodiment, only the differences between this fourth embodiment and the first embodiment are discussed in detail below.

This embodiment is similar to the previous embodiments except that the plastic tube bird feed container 104″ is a hopper type feeder. The top portion of the plastic tube bird feed container 104″ is generally cylindrical in shape and is open at the top end 6 thereof which engages with the cover 18. The bottom end of the bird feed container 104″ forms a base with facilitates dispensing of the bird feed. The upper sidewall of the plastic tube bird feed container 104″ is solid and does not have any feeding ports provided therein. The base has a central conical section 124, or some other shedding or distribution arrangement, which is designed to disburse the bird feed radially outward into an annular trough 126 were birds can access the bird feed through the cage structure 70 and a feeding aperture 110″ formed in the lower portion of the bird feed container 104. According to this embodiment, the birds are only able to feed from the lower portion of the bird feed container 104″ by accessing the bird feed through the annular feeding aperture 110″. As bird feed is eaten by feeding birds, the hopper automatically supplies additional stored bird feed in the top portion of the bird feed container 104″ into the annular trough 126 where the bird feed can be accessed via the annular feeding aperture 110″. As further features of the hopper are conventional and well known in the art, a further detailed discussion concerning the same is not provided.

Although the plastic tube bird feed container 104 is preferably cylindrical in shape, it is to be appreciated that other shapes for the plastic tube bird feed container 104 are possible such as, for example, a square transverse cross section, a rectangular transverse cross section, an octagonal transverse cross section, etc.

Since certain changes may be made in the above described releasably removable base for a bird feeder, without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore, I/we claim:

1. A bird feeder, for holding a quantity of bird feed, comprising:
an elongate bird feed container being open at top end thereof and having a base closing a bottom end thereof, and the bird feed container defining a longitudinal axis;
a hanging member connected to the bird feeder for hanging the bird feeder;
a removable cover for covering the open top end of the bird feed container, the cover having both an open position, in which the cover is spaced from the top end to facilitate supplying bird feed into the bird feed container through the open top end, and a closed position, in which the cover engages with and covers the top end of the bird feed container; and
a cage structure for encasing the bird feed container;
wherein the bird feed container is manufactured from a material which has at least one access opening formed therein and the access opening is sized to retain bird feed, once the bird feed is poured therein, but also facilitate dispensing and feeding of the bird feed through the access opening when accessed by a desired bird.

2. The bird feeder according to claim 1, wherein an outer surface of the bird feed container is spaced sufficiently from an inwardly facing surface of a sidewall of the cage structure to allow only desired birds to access and retrieve bird feed contained within the bird feed container while preventing undesired non-clinging birds and animals from accessing bird feed contained within the bird feed container.

3. The bird feeder according to claim 2, wherein the material is a mesh material which has a plurality of access openings formed therein, and each one of the access openings has a cross-sectional area of between about 0.04 and about 0.09 square inches.

4. The bird feeder according to claim 2, wherein the material is a mesh material which is defined by a plurality of spaced apart longitudinal elements and a plurality of spaced apart spaced apart horizontal elements, and the plurality of horizontal elements are attached to the plurality of longitudinal elements to form the plurality of access openings in the mesh material.

5. The bird feeder according to claim 4, wherein the longitudinal elements are spaced apart from one another by a distance of between about 1/16 to ⅓ of an inch and the horizontal elements are spaced apart from one another by between about 1/16 to ⅓ of an inch.

6. The bird feeder according to claim 5, wherein the cage structure comprises a top open cage, a bottom open cage and a side wall open cage which are all connected with one another to form a unitary structure.

7. The bird feeder according to claim 6, wherein the side wall open cage comprises a plurality of longitudinal members and a plurality of spaced apart horizontal members, the plurality of longitudinal members are attached to the plurality of horizontal members to form the side wall open cage.

8. The bird feeder according to claim 7, wherein both the side wall cage and bird feed container have a cylindrical shape.

9. The bird feeder according to claim 8, wherein the bird feed container is concentric with the side wall cage.

10. The bird feeder according to claim 7, wherein the plurality of longitudinal members of the side wall cage are spaced apart from the plurality of horizontal members of the side wall cage to define a plurality of feeding passages therein, and each feeding passage has a cross-sectional open area of between about 0.77 and about 1.56 square inches.

11. The bird feeder according to claim 6, wherein the top open cage is sized to prevent undesired birds and animals from accessing the bird feed contained within the bird feed container therethrough.

12. The bird feeder according to claim 6, wherein the bottom open cage is sized to prevent undesired birds and animals from accessing the bird feed contained within the bird feed container therethrough, and the cage structure has a coating to resist rust of the structure..

13. The bird feeder according to claim 1, wherein a top portion of the bird feed container projects out through the cage structure to facilitate engagement of the cover with the top end of the bird feed container, and the base is coupled to the cage structure to connect the bird feed container to the cage structure.

14. The bird feeder according to claim 1, wherein the bird feed container is manufactured from plastic and has a plurality of apertures formed in a sidewall thereof, each pair of apertures is generally located diametrically opposed to one another and sized to receive a corresponding feeding port therein, and a feeding port is received by each one of the apertures and the feeding port permit a bird to retrieve bird feed from the bird feeder through the feeding port when feeding.

15. The bird feeder according to claim 1, wherein the bird feed container is manufactured from plastic and has a plurality of teardrop shaped apertures formed in a sidewall thereof, and each aperture is sufficiently small in size to retain bird seed within the bird feed container while also being sufficiently large enough in size to facilitate dispensing for bird seed to a feeding bird through the aperture.

16. The bird feeder according to claim 1, wherein the bird feed container is a hopper feeder and a bottom end of the bird feed container has a central distribution arrangement which facilitates disbursing the bird feed radially outward into an annular trough were a bird can access the bird feed through the cage structure and a feeding aperture formed in a lower portion of the bird feed container.

17. The bird feeder according to claim 1, wherein a rod extends through and projects out of opposed ends of the bird feed container and the hanger member is connected to the rod to facilitate hanging of the bird feeder.

18. The bird feeder according to claim 1, wherein the base is provided with at least one drainage hole therein, which extends through a bottom surface of the base, to facilitate drainage of moisture contained within the bird feed container, and the cover is supported by the hanging member and the cover slides along the hanging member when moving from the open position to the closed position and when moving from the closed position to the open position.

19. The bird feeder according to claim 1, wherein the base has a smaller dimensioned portion, which is sized to be received by the bottom end of the bird feed container, and a larger head portion which has a larger dimension than the bottom end of the bird feed container which limits prevents further insertion of the smaller dimensioned portion of the base within the bottom end of the bird feed container.

20. A method of providing a bird feeder for holding a quantity of bird feed, comprising:
forming an elongate bird feed container with an open top end and with a base closing a bottom end of the elongate bird feed, and defining a longitudinal axis by the bird feed container;
connecting a hanging member to the bird feeder to facilitate hanging the bird feeder;
covering the open top end of the bird feed container with a removable cover, the cover having both an open position, in which the cover is spaced from the top end to facilitate supplying bird feed into the bird feed container through the open top end, and a closed position, in which the cover engages with and covers the top end of the bird feed container;
encasing the bird feed container with a cage structure; and
manufacturing the bird feed container from a material which has at least one access opening formed therein and sizing the access opening to retain bird feed, once the bird feed is poured therein, but also facilitate dispensing and feeding of the bird feed therethrough when accessed by a desired bird.
